(19) United States
(12) Patent Application Publication
(10) Pub. No.: US 2014/0315081 A1
(43) Pub. Date: Oct. 23, 2014

(54) COMPOSITE ELECTRODE MATERIAL FOR LITHIUM ION BATTERY AND PREPARATION METHOD THEREOF

(71) Applicant: GUANGZHOU INSTITUTE OF ENERGY CONVERSION, CHINESE ACADEMY OF SCIENCES, Guangzhou (CN)

(72) Inventors: Lingzhi ZHANG, Guangzhou (CN); Xinyue ZHAO, Guangzhou (CN); Xueling ZHAO, Guangzhou (CN); Suqing WANG, Guangzhou (CN)

(21) Appl. No.: 14/318,731

(22) Filed: Jun. 30, 2014

Related U.S. Application Data
(63) Continuation-in-part of application No. PCT/CN2012/084559, filed on Nov. 14, 2012.

(30) Foreign Application Priority Data
Dec. 30, 2011 (CN) 201110459817.1

(51) Int. Cl. H01M 4/62

(52) U.S. Cl. CPC H01M 4/624
USPC 429/212; 427/560

(57) ABSTRACT

The invention provides a composite electrode material for a lithium ion battery. The composite electrode material includes an electrode material and a conductive polymer. The conductive polymer coats the surface of the electrode material with a thickness of several nano-meter level. The electrode material is a positive electrode material or a negative electrode material, and the conductive polymer tends to disperse in an aqueous solution or an organic solution in the presence of a doping and dispersing agent and a dispersing medium. The conductive polymer is selected from poly(3,4-ethylenedioxythiophene) (PEDOT), polyaniline (PANT), or polypyrrole (PPy), the doping and dispersing agent is polystyrene sulfonic acid (PSS), and the dispersing medium is water; or the conductive polymer is polyaniline(emeraldine salt), and the dispersing medium is xylene. A method for preparing the composite electrode material for a lithium ion battery is also provided.

### CROSS-REFERENCE TO RELATED APPLICATIONS

This application is a continuation-in-part of International Patent Application No. PCT/CN2012/084559 with an international filing date of Nov. 14, 2012, designating the United States, now pending, and further claims priority benefits to Chinese Patent Application No. 201110459817.1 filed Dec. 30, 2011. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18^{th} Floor, Cambridge, Mass. 02142.

### BACKGROUND OF THE INVENTION

1. Field of the Invention

The invention relates to a composite electrode material for a lithium ion battery and a preparation method thereof.

2. Description of the Related Art

Conventional positive electrode materials for lithium ion batteries such as LiCoO₂, LiNi_{0.5}Mn_{1.5}O₄, LiMn₂O₄, and LiFePO₄, and negative electrode materials such as MoS₂, graphite, and Li₄Ti₅O₁₂, both have a low conductivity. Carbon coating method can improve the conductivity to some extent, but it requires long operating time, high thermal treatment temperature, and protection from inert gas, and the resulting mixture is nonuniform.

Recently, featuring high conductivity and good lattice elasticity, conductive polymers including 3,4-ethylenedioxythiophene (EDOT), polyaniline (PANT), and polypyrrole (PPy) have been experimenting as a composite/surface coating material for the electrode material of lithium ion batteries. For example, PPy is coated on LiFePO₄ by in-situ electrochemical polymerization to form a composite electrode material. However, these composites are usually bulky materials with electrode particles embedded in the bulky conducting polymer matrix. And, the electrochemical polymerization has a complicated technological process, which limits the industrial production.

### SUMMARY OF THE INVENTION

In view of the above-described problems, it is one objective of the invention to provide a composite electrode material with improved electric conductivity for a lithium ion battery. Specifically, the composite electrode material with conducting polymer coating layer with a thickness of nano-meter level on the surface is hydrophilic, which enables the electrode active material easier to be dispersed to form homogeneous slurry in the process of fabricating the electrode sheet in industry, especially for the nano-sized electrode active materials.

It is another objective of the invention to provide a method for preparing a composite electrode material for a lithium ion battery. The method features simple process, low cost, high efficiency, environmental friendliness, and is easy for industrialization.

To achieve the above objective, in accordance with one embodiment of the invention, there is provided a composite electrode material for a lithium ion battery, comprising an electrode material and a conductive polymer, the conductive polymer coating the electrode material, the electrode material being a positive electrode material or a negative electrode material, and the conductive polymer having a tendency to disperse in an aqueous solution or an organic solution in the presence of a doping and dispersing agent and a dispersing medium. The conductive polymer is selected from poly(3,4-ethylenedioxythiophene) (PEDOT), polyaniline (PANT), or polypyrrole (PPy), and the doping and dispersing agent is polystyrene sulfonic acid (PPS), of which mixtures are abbreviated as PEDOT:PSS, PANI:PSS, and PPy:PSS, respectively. The conductive polymer is polyaniline(emeraldine salt), and the dispersing medium is xylene, of which a mixture is abbreviated as PANI(xylene).

In a class of this embodiment, a solid content in the PEDOT:PSS is between 0.9 and 1.3 wt. %, and solid contents in the PANI:PSS and the PPy:PSS are both between 2 and 2.2 wt. %.

In a class of this embodiment, in the mixture of polyaniline(emeraldine salt) and xylene, a weight percentage of polyaniline(emeraldine salt) is between 2 and 3 wt. %.

The active component of the conductive polymer coated electrode material is an electrode material purchased from markets. By immersing the electrode material in the conductive polymer, a conductive polymer/electrode material composite material is obtained after filtration to remove the solvent.

The preparation of the conductive polymer coated electrode material comprises immersing a positive electrode material or a negative electrode material in a conductive polymer solution. By means of immersing and coating, the conductive polymer coated electrode material is obtained after filtration to remove the solvent. The process is simple, does not need the thermal treatment at high temperature. The immersing method ensures the coating is uniform, and the bonding of the conductive polymer membrane and the powdery particles of the electrode material is compact, thereby greatly improving the electric conductivity and electrochemical properties of the composite electrode material. The obtained composite electrode material has high specific capacity, high charge-discharge efficiency, and long cycle life.

In accordance with another embodiment of the invention, there provided is a method for preparing a composite electrode material. The method comprises immersing the positive electrode material or the negative electrode material of the lithium ion battery in an aqueous solution or an organic solution of the conductive polymer, allowing the conductive polymer to uniformly coat a surface of the electrode material by means of ultrasonic dispersion, and filtering and drying the electrode material to yield a conductive polymer coated electrode material.

Specifically, the method comprises the following steps:
1) adding dropwise an ammonia solution or an aqueous solution of lithium hydroxide to the aqueous solution or the organic solution of the conductive polymer to adjust a pH value thereof to be between 6 and 9;
2) adding a powder of the positive electrode material or the negative electrode material of the lithium ion battery to the aqueous solution or the organic solution of the conductive polymer obtained in step 1), dispersing and stirring the aqueous solution or the organic solution in the presence of ultrasonic wave;
3) centrifuging/filtering a mixture obtained in step 2) for removal of residual aqueous solution or organic solution to yield a powder; and
4) drying the power obtained in step 3).

In the preparation process, the addition amount of the raw materials, the supersonic dispersion time, and the pH value of reaction solution are regulated as needed to obtain the most desired products.

In a class of this embodiment, the aqueous solution of the conductive polymer is PEDOT:PSS, PANI:PSS, or PPy:PSS, and a solid content in the PEDOT:PSS is between 0.9 and 1.3 wt. %, and solid contents in the PANI:PSS and the PPy:PSS are both between 2 and 2.2 wt. %.

In a class of this embodiment, the organic solution of the conductive polymer is a mixture of polyaniline (emeraldine salt) and xylene, and in the mixture of polyaniline (emeraldine salt) and xylene, a weight percentage of polyaniline (emeraldine salt) is between 2 and 3 wt. %.

In a class of this embodiment, in step 2), the positive electrode material of the lithium ion battery comprises LiCoO₂, LiNiO₂, LiMnO₂, LiNi_{0.5}Mn_{1.5}O₄, LiMn₂O₄, LiFePO₄, LiNiₓCo₁₋ₓO₂ where x=0.01 to 0.99, a ternary positive electrode material comprising LiMnₓCo_{y}Ni_{z}O₂ and LiNiₓCo_{y}Al_{z}O₂where x+y+z=1, or lithium-rich positive material of Li₂MnO₃.(1-x)LiMeO₂where 0<x<1, Me=Ni, Co, Mn, or a mixture thereof; and the negative electrode material of the lithium ion battery comprises MoS₂, graphite, Li₄Ti₅O₁₂, and silicon-based negative materials, or a mixture thereof. The positive electrode material or the negative electrode material of the lithium ion battery has a concentration in the aqueous solution or the organic solution of the conductive polymer of between 0.1 and 2 g/mL. An addition amount of the aqueous solution of the PEDOT:PSS is satisfied to completely immerse the powder of the positive electrode material or the negative electrode material, and an addition amount of the aqueous solution of the PANI:PSS or PPy:PPS is that: a mass ratio of the positive electrode material or the negative electrode material to the conductive polymer is between 10 and 100:1. An addition amount of the mixture of polyaniline (emeraldine salt) and xylene is satisfied to completely immerse the powder of the positive electrode material or the negative electrode material, and a mass ratio of the positive electrode material or the negative electrode material to the conductive polymer is between 100 and 200:1.

In a class of this embodiment, the supersonic dispersion lasts for between 0.2 and 3 hours.

In a class of this embodiment, the drying is carried out in an oven, or by a rotary evaporator.

Advantages according to embodiments of the invention are summarized as follows:

1. The method of the invention is conducted in an aqueous solution or organic solution at room temperature, so that it only consumes a small amount of energy and does not necessitate inert gas for protection.

2. The method of the invention employs the conductive polymer solution to immerse the electrode material, and the involved liquid is water or an organic solution which is prone to uniformly coat the surface of the particles of the electrode material, thereby being beneficial to improve the conductivity of the electrode material and significantly improve the electrochemical properties and cycle performance of the composite electrode material.

3. The method of the invention involves cheap raw materials, simple process, no high requirements on the device, free of high temperature thermal treatment, and low production costs, thereby being easy for large-scale industrial promotion and having good application prospects in the lithium ion batteries.

4. No toxic or hazardous intermediates are produced during the production of the electrode material, so that the production process of the electrode material is environmentally friendly.

5. The method of the invention is applicable for compositing of the electrode material and the conductive polymer in other electrochemical energy storage devices (like super capacitors) and organic solar cells (like TiO₂ electrodes in dye-sensitized solar cells).

### BRIEF DESCRIPTION OF THE DRAWINGS

The invention is described hereinbelow with reference to accompanying drawings, in which:

FIG. 1 shows a Fourier transform infrared spectrum of LiMn₂O₄ and LiMn₂O₄/PEDOT:PSS prepared in accordance with Example 3 of the invention;

FIG. 2 shows a Fourier transform infrared spectrum of C and C/PEDOT:PSS prepared in accordance with Example 6 of the invention;

FIG. 3A shows a Fourier transform infrared spectrum of Li₄Ti₅O₁₂ and Li₄Ti₅O₁₂/PANI:PSS prepared in accordance with Example 8 of the invention;

FIG. 3B shows a Fourier transform infrared spectrum of Li₄Ti₅O₁₂ and Li₄Ti₅O₁₂/PPy:PSS prepared in accordance with Example 9 of the invention;

FIG. 4 shows X-ray diffraction spectra of MoS₂ and MoS₂/PEDOT:PSS prepared in accordance with Example 5 of the invention;

FIG. 5A shows X-ray diffraction spectra of Li₄Ti₅O₁₂ and Li₄Ti₅O₁₂/PANI:PSS with different weight ratio (50:1; 100:1) prepared in accordance with Example 8 of the invention;

FIG. 5B shows X-ray diffraction spectra of Li₄Ti₅O₁₂ and Li₄Ti₅O₁₂/PANI(xylene) with different weight ratio (100:1; 200:1) prepared in accordance with Example 10 of the invention;

FIG. 6A shows a scanning electron microscope image of a graphite (C) electrode after 50 cycles, and FIG. 6B is a scanning electron microscope image of an electrode of C/PEDOT:PSS prepared in accordance with Example 6 of the invention after 50 cycles;

FIG. 7 shows charge-discharge curves (the first three cycles) of composite electrode materials prepared in accordance with Examples 1-7 of the invention at the charge-discharge current density of C/10, in which FIG. 7A represents LiCoO₂/PEDOT:PSS, FIG. 7B represents LiNi_{0.5}Mn_{1.5}O₄/PEDOT:PSS, FIG. 7C represents LiMn₂O₄/PEDOT:PSS, FIG. 7D represents Li₄Ti₅O₁₂/PEDOT:PSS, FIG. 7E represents LiFePO₄/PEDOT:PSS, FIG. 7F represents initial charge discharge curves of MoS₂/PEDOT:PSS at the charge-discharge current density of 50 mA/g, FIG. 7G represents C/PEDOT:PSS at the charge-discharge current density of C/5;

FIG. 8 shows charge-discharge curves (the first three cycles) of composite electrode materials prepared in accordance with Examples 8-9 of the invention at the charge-discharge current density of C/10, in which FIG. 8A represents LTO/PANI:PSS=50:1, FIG. 8B represents LTO/PANI:PSS=100:1, FIG. 8C represents LTO/PPy:PSS=50:1, FIG. 8D represents LTO/PPy:PSS=100:1;

FIG. 9 shows cycle performance of composite electrode material prepared in accordance with Examples 1-7 of the invention at the charge-discharge current density of C/5, in which FIG. 9A represents the comparison of cycle performance between pristine LiCoO₂ and coated LiCoO₂, FIG. 9B represents the comparison of cycle performance between pristine LiNi_{0.5}Mn_{1.5}O₄ and coated LiNi_{0.5}Mn_{1.5}O₄, FIG. 9C represents the comparison of cycle performance between pristine LiMn₂O₄ and coated LiMn₂O₄, FIG. 9D represents the comparison of cycle performance between pristine Li₄Ti₅O₁₂ and coated Li₄Ti₅O₁₂, FIG. 9E represents the comparison of cycle performance between pristine LiFePO₄ and coated LiFePO₄, FIG. 9F represents the comparison of cycle performance between pristine MoS₂ and coated MoS₂ at the current density of 50 mA/g, FIG. 9G represents the comparison of cycle performance between pristine C and coated C at the current density of C/2;

FIG. 10 shows the cycle performance curves of composite electrode materials prepared in accordance with Examples 8-10 of the invention at the charge-discharge current density of C/10, in which FIG. 10A represents the comparison of cycle performance between pristine LTO, LTO/PANI:PSS=50:1 and LTO/PANI:PSS=100:1, FIG. 10B represents the comparison of cycle performance between pristine LTO, LTO/PPy:PSS=50:1 and LTO/PPy:PSS=100:1, FIG. 10C represents the comparison of cycle performance between LTO, LTO/PANI(xylene)=100:1 and LTO/PANI(xylene)=200:1;

FIG. 11 shows a rate capability curve of an electrode material prepared in Example 6 of the invention at constant current under different current density;

FIGS. 12(A, B, C) show the rate capability curves of the composite electrode materials prepared in Examples 8-10 of the invention at constant current under different current density, in which FIG. 12A represents the comparison of the rate capability between pristine LTO, LTO/PANI:PSS=50:1 and LTO/PANI:PSS=100:1, FIG. 12B represents the comparison of the rate capability between pristine LTO, LTO/PPy:PSS=50:1 and LTO/PPy:PSS=100:1, FIG. 12C represents the comparison of the rate capability between LTO, LTO/PANI(xylene)=100:1 and LTO/PANI(xylene)=200:1;

FIG. 13A shows AC impedance curves of a composite electrode material prepared in Example 9 of the invention after 5 cycles;

FIG. 13B shows AC impedance curves of a composite electrode material prepared in Example 8 of the invention after 5 cycles;

FIG. 14 shows high resolution transmission electron microscope image of MoS₂/PEDOT:PSS prepared in accordance with Example 5 of the invention; and

FIG. 15 shows high resolution transmission electron microscope image of Li₄Ti₅O₁₂/PPy:PSS prepared in accordance with Example 9 of the invention.

### DETAILED DESCRIPTION OF THE EMBODIMENTS

For further illustrating the invention, experiments detailing a composite electrode material for a lithium ion battery and a preparation method thereof are described below. It should be noted that the following examples are intended to describe and not to limit the invention.

In the following examples, the raw materials are commercially obtained from the market. The solid content of the PEDOT:PSS is between 0.9 and 1.3 wt. %. The solid contents in the PANI:PSS and the PPy:PSS are both between 2 and 2.2 wt. %. In the mixture of polyaniline(emeraldine salt) and xylene, the weight percentage of polyaniline(emeraldine salt) is between 2 and 3 wt. %. The electrode material of the lithium ion battery is purchased from the market including but not limited to graphite, LiCoO₂, LiNi_{0.5}Mn_{1.5}O₄, LiMn₂O₄, LiFePO₄, MoS₂, and Li₄Ti₅O₁₂.

In the specification, PEDOT:PSS refers to a mixture of PEDOT and PSS. PANI:PSS refers to a mixture of PANI and PSS. PPy:PSS refers to a mixture of PPy and PSS. LiCoO₂/PEDOT:PSS means immersing LiCoO₂ in the mixture of PEDOT and PSS to yield a coated LiCoO₂. The descriptions similar to the above have the analogical explanation.

### EXAMPLE 1

LiCoO₂/PEDOT:PSS

Ammonia solution was added to the aqueous solution of PEDOT:PSS to regulate the pH value thereof to be neutral (between 6 and 9). 2 g of LiCoO₂ powder was slowly added to 10 mL of the aqueous solution of PEDOT:PSS. The resulting mixture was allowed to disperse for 30 min in the presence of ultrasonic wave, filtered, dried at 80° C. for 3 hours, ground completely, and dried at 120° C. for 2 hours. Thereafter, a collected product was fully ground and uniformly mixed with acetylene black and poly(vinylidene fluoride) (PVDF) in a weight ratio of 80:10:10. After coating and drying at 80° C. for 24 hours, an electrode sheet of LiCoO₂ was obtained. With a lithium plate as a counter electrode, polyethylene membrane as a battery separator, and 1 M LiPF₆/EC:DEC:DMC (v:v:v=1:1:1) as an electrolyte, a button cell (CR2025) was assembled. The charge-discharge test of the button cell under constant current showed that, the voltage range was between 3.0 and 4.2 V.

### EXAMPLE 2

LiNi_{0.5}Mn_{1.5}O₄/PEDOT:PSS

Ammonia solution was added to the aqueous solution of PEDOT:PSS to regulate the pH value thereof to be neutral (between 6 and 9). 0.5 g of LiNi_{0.5}Mn_{1.5}O₄ powder was slowly added to 2 mL of the aqueous solution of PEDOT:PSS. The resulting mixture was allowed to disperse for 30 min in the presence of ultrasonic wave, self-precipitated, centrifuged, and dried at between 60 and 120° C. for 24 hours. Thereafter, a collected product was fully ground and uniformly mixed with acetylene black and PVDF in a weight ratio of 80:10:10. After coating and drying at 80° C. for 24 hours, an electrode sheet of LiNi_{0.5}Mn_{1.5}O₄ was obtained. With a lithium plate as a counter electrode, a polyethylene membrane as a battery separator, and 1 M LiPF₆/EC:DEC (v:v=1:1) as an electrolyte, a button cell (CR2025) was assembled. The charge-discharge test of the button cell under constant current showed that, the voltage range was between 3.5 and 5.0 V.

### EXAMPLE 3

LiMn₂O₄/PEDOT:PSS

Ammonia solution was added to the aqueous solution of PEDOT:PSS to regulate the pH value thereof to be neutral (between 6 and 9). 0.5 g of LiMn₂O₄ powder was slowly added to 2 mL of the aqueous solution of PEDOT:PSS. The resulting mixture was allowed to disperse for 30 min in the presence of ultrasonic wave, self-precipitated, centrifuged, and dried at between 60 and 120° C. for 24 hours. Thereafter, a collected product was fully ground and uniformly mixed with acetylene black and PVDF in a weight ratio of 80:10:10. After coating and drying at 80° C. for 24 hours, an electrode sheet of LiMn₂O₄ was obtained. With a lithium plate as a counter electrode, a polyethylene membrane as a battery separator, and 1 M LiPF₆/EC:DEC (v:v=1:1) as an electrolyte, a button cell (CR2025) was assembled. The charge-discharge test of the button cell under constant current showed that, the voltage range was between 3.5 and 4.3 V.

### EXAMPLE 4

LiFePO₄/PEDOT:PSS

Ammonia solution was added to the aqueous solution of PEDOT:PSS to regulate the pH value thereof to be neutral (between 6 and 9). 0.5 g of LiFePO₄ powder was slowly added to 1 mL of the aqueous solution of PEDOT:PSS. The resulting mixture was allowed to disperse for 30 min in the presence of ultrasonic wave, self-precipitated, centrifuged, and dried at between 60 and 120° C. for 24 hours. Thereafter, a collected product was fully ground and uniformly mixed with acetylene black and PVDF in a weight ratio of 80:10:10. After coating and drying at 80° C. for 24 hours, an electrode sheet of LiFePO₄ was obtained. With a lithium plate as a counter electrode, a polyethylene membrane as a battery separator, and 1 M LiPF₆/EC:DEC (v:v=1:1) as an electrolyte, a button cell (CR2025) was assembled. The charge-discharge test of the button cell under constant current showed that, the voltage range was between 2.7 and 4.0 V.

### EXAMPLE 5

MoS₂/PEDOT:PSS

Ammonia solution was added to the aqueous solution of PEDOT:PSS to regulate the pH value thereof to be neutral (between 6 and 9). To a beaker, 0.4 g of MoS₂, 5 g of the aqueous solution of PEDOT/PSS, and 25 mL of deionized water were added. The resulting mixture was treated by an ultrasonic cell disrupter for ultrasonic immersion, and dried at 80° C. overnight, so that black powder was obtained. Thereafter, a collected product was fully ground and uniformly mixed with acetylene black and PVDF in a weight ratio of 70:20:10. After coating and drying at 80° C. for 24 hours, an electrode sheet of LiFePO₄ was obtained. With a lithium plate as a counter electrode, a polyethylene membrane as a battery separator, and 1 M LiPF₆/EC:DEC (v:v=1:1) as an electrolyte, a button cell (CR2025) was assembled. The charge-discharge test of the button cell under constant current showed that, the voltage range was between 0.01 and 3.0 V.

### EXAMPLE 6

Graphite/PEDOT:PSS

Lithium hydroxide was added to the aqueous solution of PEDOT:PSS to regulate the pH value thereof to be neutral (between 7 and 8). 2 g of graphite and 4 g of the aqueous solution of PEDOT/PSS were added to a beaker to allow a weight ratio of C: (PEODT:PSS) to be 50:1, and 25 mL of deionized water was added to yield a mixed solution. The mixed solution was then stirred by a magnetic force for 2 hours and filtered, and further filtered by ethanol, deionized water, and ethanol, respectively. A product after filtration was vacuum dried at 90° C. overnight to obtain coated powder. Thereafter, a collected product was fully ground and uniformly mixed with acetylene black and PVDF in a weight ratio of 90:5:5. After coating and drying at 80° C. for 24 hours, an electrode sheet of LiFePO₄ was obtained. With a lithium plate as a counter electrode, a polyethylene membrane as a battery separator, and 1 M LiPF₆/EC:DEC:DMC (v:v:v=1:1:1) as an electrolyte, a button cell (CR2025) was assembled. The charge-discharge test of the button cell under constant current showed that, the voltage range was between 0.01 and 3 V.

### EXAMPLE 7

Li₄Ti₅O₁₂/PEDOT:PSS

Ammonia solution was added to the aqueous solution of PEDOT:PSS to regulate the pH value thereof to be neutral (between 6 and 9). 3 g of Li₄Ti₅O₁₂ powder was slowly added to 5 mL of the aqueous solution of PEDOT:PSS. The resulting mixture was allowed to disperse for 30 min in the presence of ultrasonic wave, self-precipitated, centrifuged, and dried at between 60 and 120° C. for 24 hours. Thereafter, a collected product was fully ground and uniformly mixed with acetylene black and PVDF in a weight ratio of 80:10:10. After coating and drying at 80° C. for 24 hours, an electrode sheet of Li₄Ti₅O₁₂ was obtained. With a lithium plate as a counter electrode, a polyethylene membrane as a battery separator, and 1 M LiPF₆/EC:DEC (v:v=1:1) as an electrolyte, a button cell (CR2025) was assembled. The charge-discharge test of the button cell under constant current showed that, the voltage range was between 1.0 and 2.5 V.

### EXAMPLE 8

Li₄Ti₅O₁₂/PANI:PSS (LTO/PANI:PSS in Abbreviation)

Lithium hydroxide was added to the aqueous solution of PPy:PSS to regulate the pH value thereof to be neutral (between 8 and 9). 1.00 g of Li₄Ti₅O₁₂ powder was slowly added to 0.94 g of the aqueous solution of PANI:PSS, that is, 0.02 g of PANI:PSS, so that a first mixed solution having a weight ratio of LTO/PANI:PSS of 50:1 was obtained. Another 1.00 g of Li₄Ti₅O₁₂ powder was slowly added to 0.47 g of the aqueous solution of PPy:PSS, that is, 0.01 g of PPy:PSS, so that a second mixed solution having a weight ratio of LTO/PPy:PSS of 100:1 was obtained. The first mixed solution and the second mixed solution were separately stirred for 2 hours, dispersed for 1 hour in the presence of ultrasonic wave, stirred for another 2 hours, and dried at 70° C. for 20 hours. Thereafter, a collected product was fully ground and uniformly mixed with acetylene black and PVDF in a weight ratio of 80:10:10. After coating and drying at 80° C. for 24 hours, an electrode sheet of Li₄Ti₅O₁₂ was obtained. With a lithium plate as a counter electrode, a polyethylene membrane as a battery separator, and 1 M LiPF₆/EC:DMC (v:v=1:1) as an electrolyte, a button cell (CR2025) was assembled. The charge-discharge test of the button cell under constant current showed that, the voltage range was between 1.0 and 2.5 V.

### EXAMPLE 9

Li₄Ti₅O₁₂/PPy:PSS (LTO/PPy:PSS in Abbreviation)

Lithium hydroxide was added to the aqueous solution of PPy:PSS to regulate the pH value thereof to be neutral (between 8 and 9). 1.00 g of Li₄Ti₅O₁₂ powder was slowly added to 4.9 g of the aqueous solution of PPy:PSS, that is, 0.1 g of PPy:PSS, so that a first mixed solution having a weight ratio of LTO/PANI:PSS of 10:1 was obtained. 1.00 g of Li₄Ti₅O₁₂ powder was slowly added to 0.98 g of the aqueous solution of PPy:PSS, that is, 0.02 g of PPy:PSS, so that a second mixed solution having a weight ratio of LTO/PPy:PSS of 50:1 was obtained. 1.00 g of Li₄Ti₅O₁₂ powder was slowly added to 0.49 g of the aqueous solution of PPy:PSS, that is, 0.01 g of PPy:PSS, so that a third mixed solution having a weight ratio of LTO/PPy:PSS of 100:1 was obtained. The first mixed solution, the second mixed solution, and the third mixed solution were separately stirred for 2 hours, dispersed for 1 hour in the presence of ultrasonic wave, stirred for another 2 hours, and dried at 70° C. for 20 hours. Thereafter, a collected product was fully ground and uniformly mixed with acetylene black and PVDF in a weight ratio of 80:10:10. After coating and drying at 80° C. for 24 hours, an electrode sheet of Li₄Ti₅O₁₂ was obtained. With a lithium plate as a counter electrode, a polyethylene membrane as a battery separator, and 1 M LiPF₆/EC:DMC (v:v=1:1) as an electrolyte, a button cell (CR2025) was assembled. The charge-discharge test of the button cell under constant current showed that, the voltage range was between 1.0 and 2.5 V.

### EXAMPLE 10

Li₄Ti₅O₁₂/PANI (xylene) (LTO/PANI(xylene) in Abbreviation)

1.00 g of Li₄Ti₅O₁₂ powder was slowly added to 0.40 g of the dispersion solution of PANI(xylene), that is, 0.01 g of PANI(xylene), so that a first mixed solution having a weight ratio of LTO/PANI(xylene) of 100:1 was obtained. Another 1.00 g of Li₄Ti₅O₁₂ powder was slowly added to 0.20 g of the dispersion of PANI(xylene), that is, 0.005 g of PANI(xylene), so that a second mixed solution having a weight ratio of LTO/PANI(xylene) of 200:1 was obtained. The first mixed solution and the second mixed solution were separately stirred for 2 hours, dispersed for 1 hour in the presence of ultrasonic wave, stirred for another 2 hours, and dried at 70° C. for 20 hours. Thereafter, a collected product was fully ground and uniformly mixed with acetylene black and PVDF in a weight ratio of 80:10:10. After coating and drying at 80° C. for 24 hours, an electrode sheet of Li₄Ti₅O₁₂ was obtained. With a lithium plate as a counter electrode, a polyethylene membrane as a battery separator, and 1 M LiPF₆/EC:DMC (v:v=1:1) as an electrolyte, a button cell (CR2025) was assembled. The charge-discharge test of the button cell under constant current showed that, the voltage range was between 1.0 and 2.5 V.

The following descriptions show the experimental results of the composite electrode material for a lithium ion battery based on Fourier transform infrared spectrum analysis, X-ray diffraction spectra analysis, Field emission scanning electron microscopy spectra analysis, and electrochemical measurement.

1. Fourier Transform Infrared Spectrum Analysis

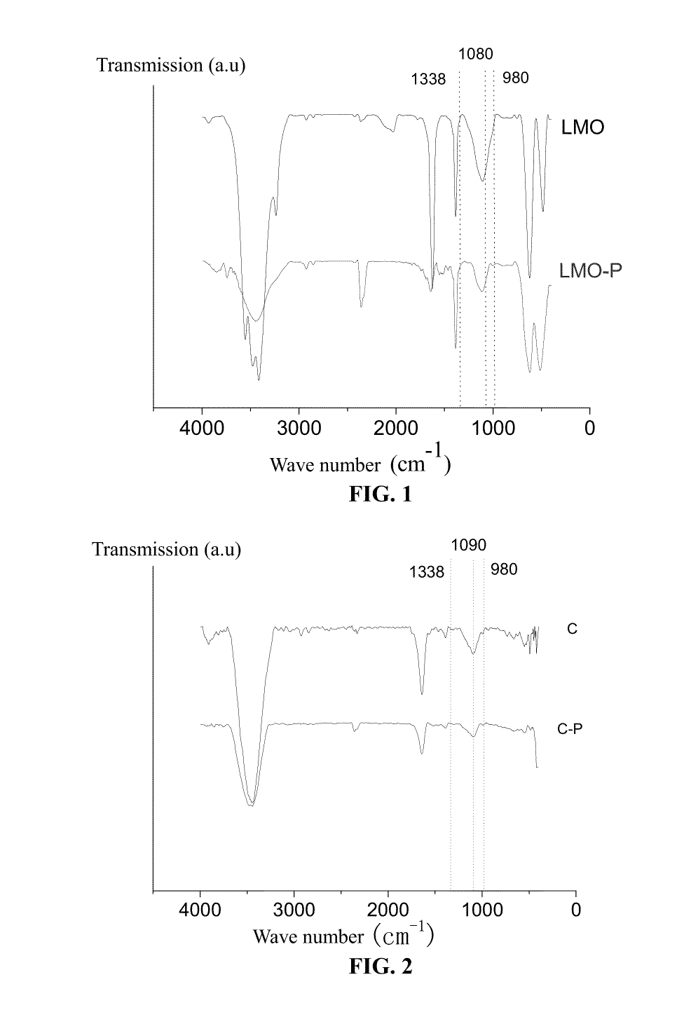

FIG. 1 shows a comparison of the infra-red spectrum of LiMn₂O₄/PEDOT:PSS and LiMn₂O₄. It is known in the prior art that the peak at 980 cm⁻¹ represents the peak of —C—S—, the peak at 1090 cm⁻¹ represents the stretching vibration peak of —C—O—C—, and the peak at 1338 cm⁻¹ represents the stretching vibration peak of C—C, C═C benzoquinonyl (Polym. Adv. Technol., 21 (2010) 651; Phys. Stat. Sol., 205 (2008) 1451). As shown in FIG. 1, LiMn₂O₄ samples after being immersed in the PEDOT:PSS solution have two small peaks at 980 cm⁻¹ and 1338 cm⁻¹, which shows that the PEDOT:PSS is coated on the surface of the LiMn₂O₄ samples by means of immersing.

FIG. 2 shows a comparison of the infra-red spectrum of C/PEDOT:PSS and C. As shown in the figure, C samples after being immersed in the PEDOT:PSS solution have two small peaks at 980 cm⁻¹ and 1338 cm⁻¹, which are characteristic peaks of PEDOT:PSS. That is to say, the PEDOT:PSS is coated on the surface of graphite by means of immersing.

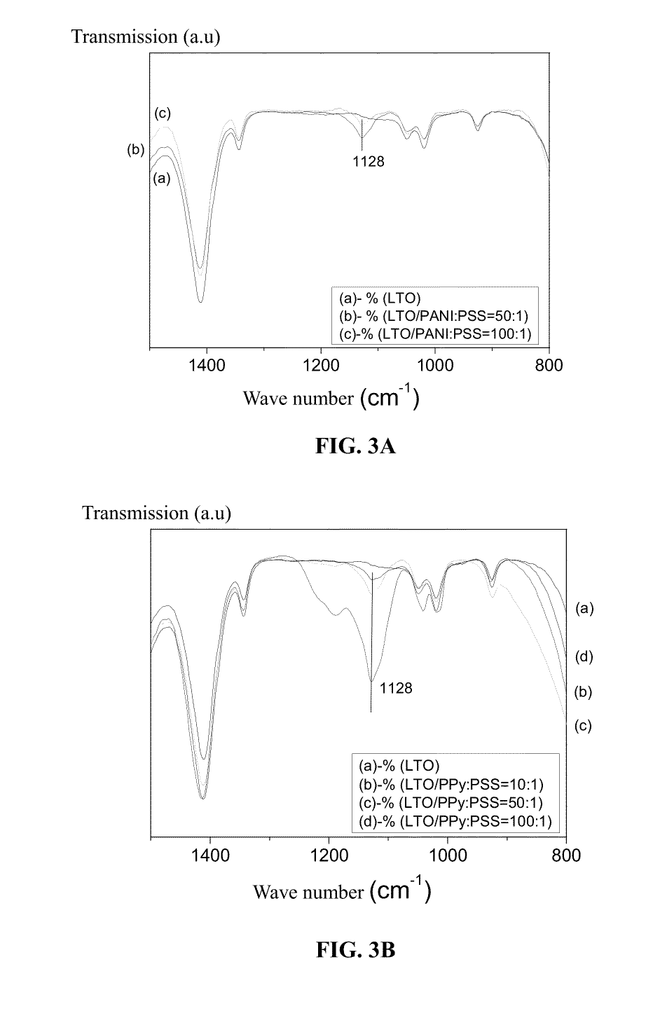

FIGS. 3A and 3B show a Fourier transform infrared spectrum of LTO/PANI:PSS and LTO/PPy:PSS of the invention. It is known in the prior art that the peak at 1130 cm⁻¹ represents the vibration of the plane frame of PANI:PSS and PPy:PSS (Adv. Mater. 19 (2007), 1772). As shown in FIG. 3, although the addition amount of the conductive polymer is small, LTO after being immersed in the aqueous solution of PANI:PSS and PPy:PSS has small peak at 1128 cm⁻¹, which shows that the PANI:PSS and PPy:PSS are coated on the surface of the LTO powders.

2. X-Ray Diffraction Spectra Analysis

FIG. 4 shows a comparison of the X-ray diffraction spectra of MoS₂and MoS₂/PEDOT:PSS. As shown in the figure, after being coated by PEDOT:PSS, the (002) crystal plane diffraction peak of MoS₂ is hidden, which means the surface of MoS₂ is coated by PEDOT:PSS.

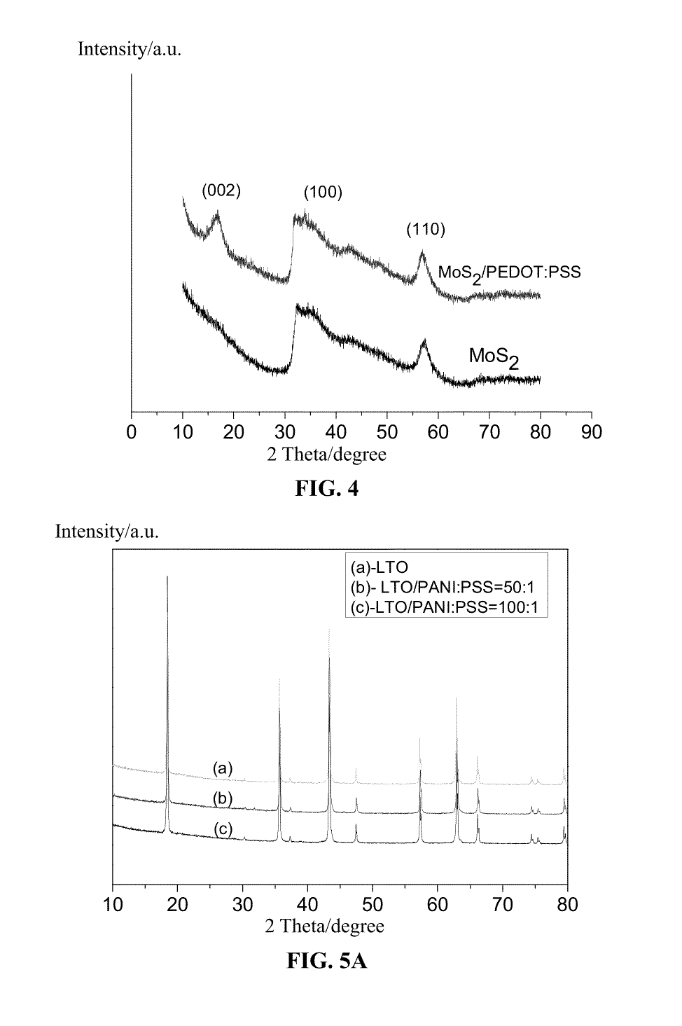

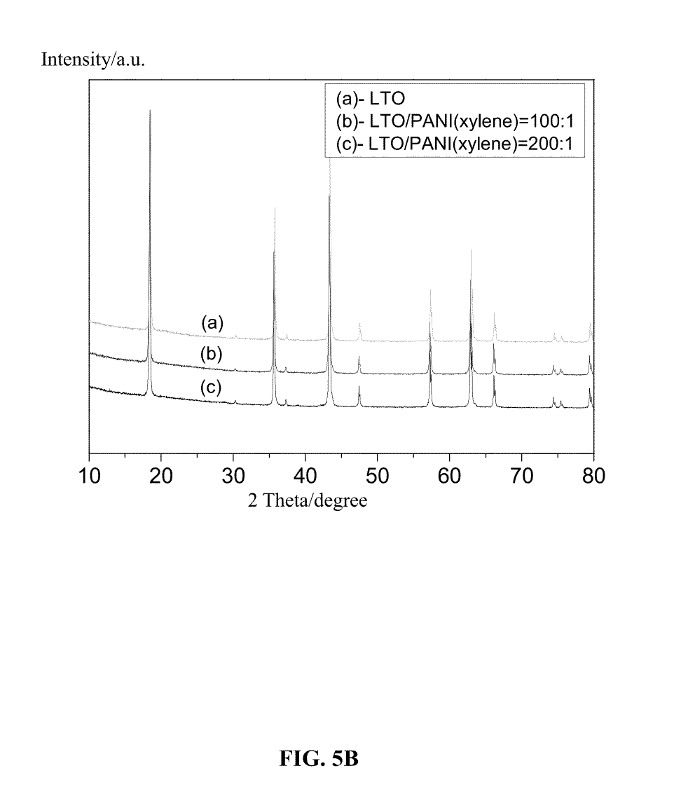

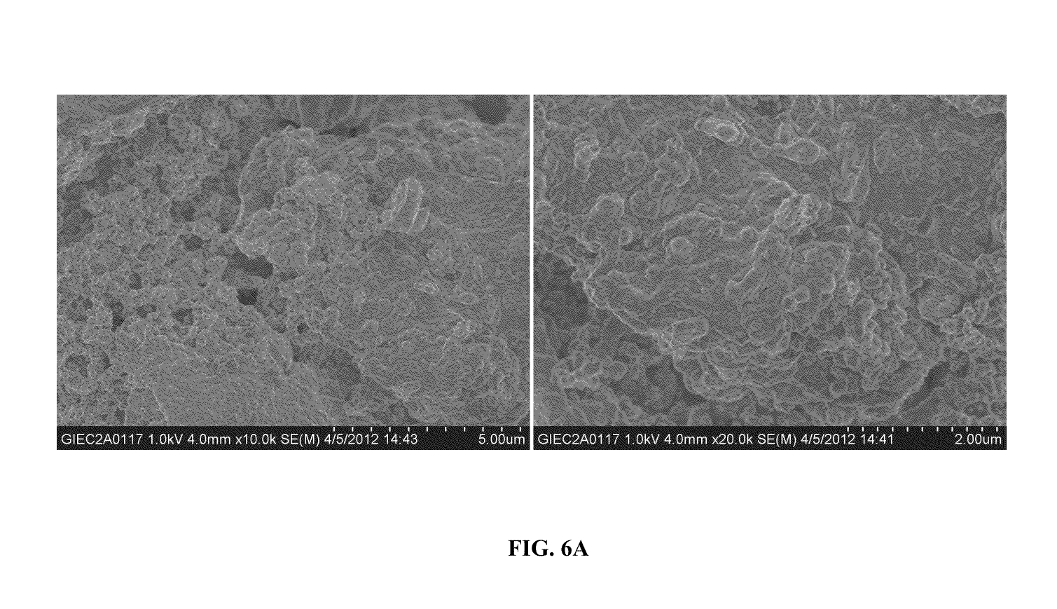

FIGS. 5A and 5B shows the X-ray diffraction spectra of LTO/PANI:PSS and LTO/PANI(xylene) of the invention. As shown in the figure, because LTO has good crystallinity, the conductive polymer PANI is amorphous and the addition amount thereof is small, the X-ray diffraction spectra of the sample has almost no change before and after coating. That is to say, LTO still has good crystallinity before and after being coated.

3. Field Emission Scanning Electron Microscopy Analysis

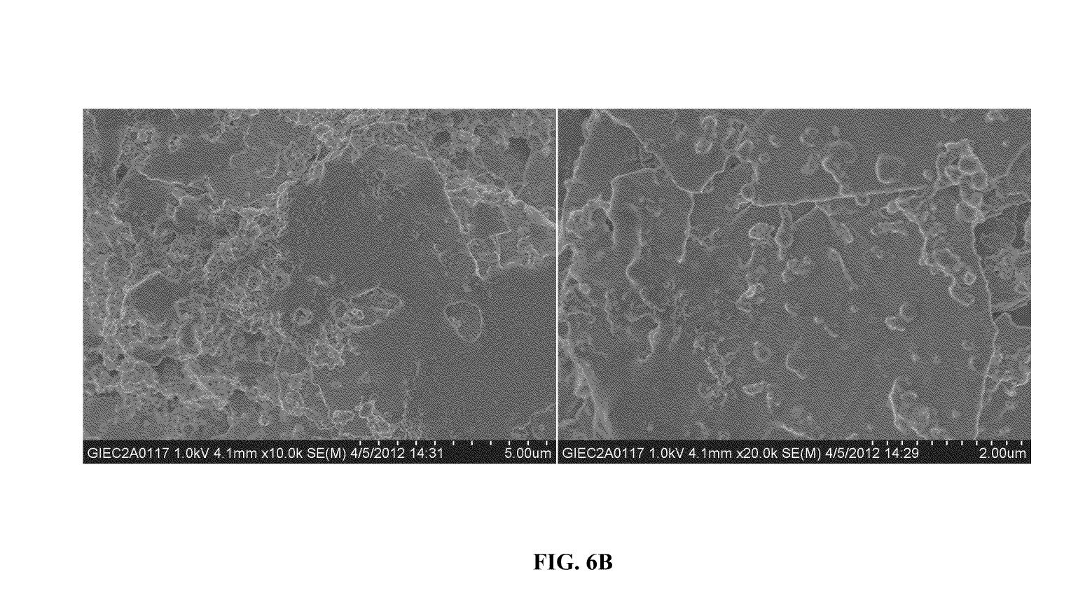

FIG. 6 shows the scanning electron microscope image of C/PEDOT:PSS. As shown in the figure, after 50 charge-discharge cycles, the surface of the graphite (C) electrode without the coating of PEDOT:PSS is nonuniform, as the arrow points out, lithiation/delithiation zones of the graphite is loose and porous due to the detachment of surface slices. The surface of the graphite electrode with the coating of PEDOT:PSS is uniform after 50 charge-discharge cycles, and the lamellar structure of the graphite remains good.

4. Voltage Plateau Curve

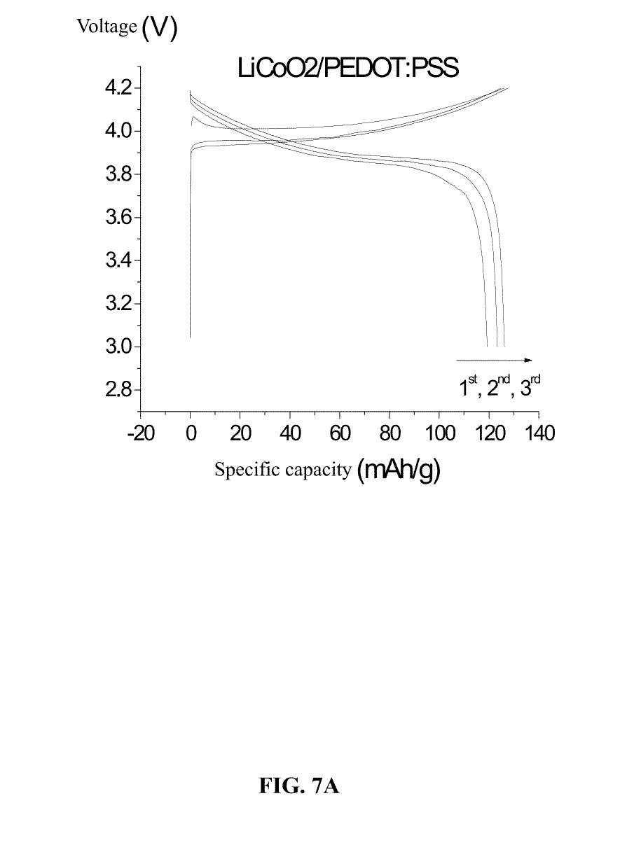

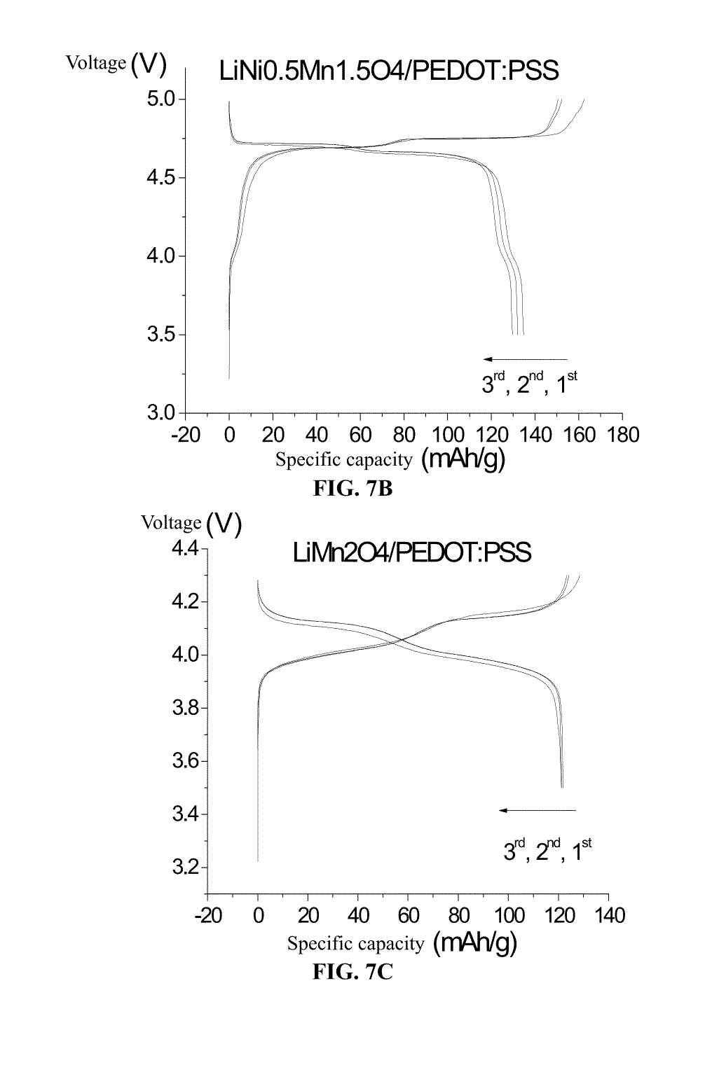

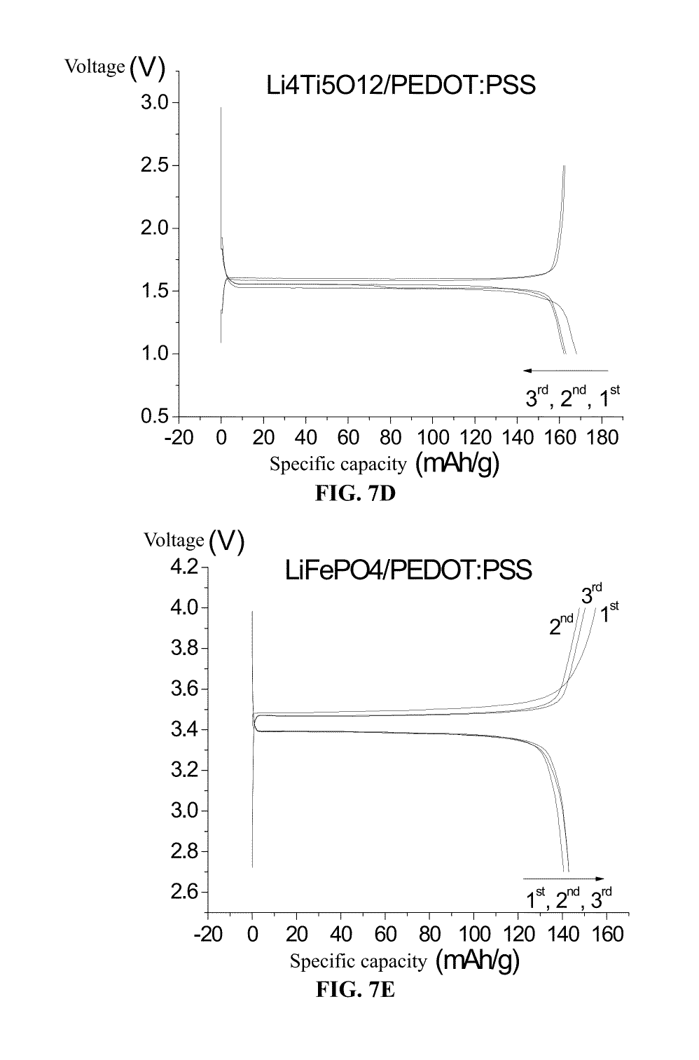

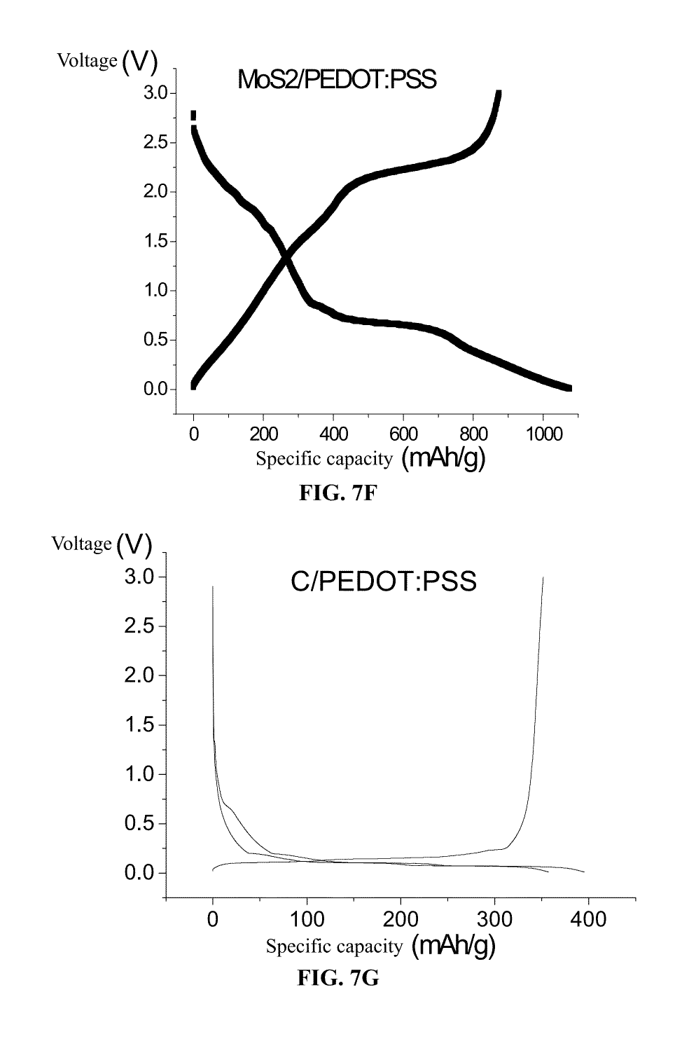

FIG. 7 shows the charge-discharge curves (the first three cycles) of the materials and composite electrode material involved in the invention at the charge-discharge current density of C/10. As shown in the figure, after being coated by the PEDOT:PSS solution, the discharge capacity of the powdery electrode materials (LiCoO₂, LiNi_{0.5}Mn_{1.5}O₄, LiMn₂O₄, Li₄Ti₅O₁₂, LiFePO₄, MoS₂, graphite C) has almost no change, even the discharge specific capacity of some samples is increased. Specifically, the initial discharge specific capacity of LiCoO₂ is decreased from 130.1 mAh/g to 119.2 mAh/g; the initial discharge specific capacity of LiNi_{0.5}Mn_{1.5}O₄ is decreased from 132.8 mAh/g to 130.2 mAh/g; the initial discharge specific capacity of LiMn₂O₄ is increased from 115.2 mAh/g to 118.4 mAh/g; the initial discharge specific capacity of Li₄Ti₅O₁₂ is increased from 163.7 mAh/g to 168.1 mAh/g; the initial discharge specific capacity of LiFePO₄ is increased from 137.9 mAh/g to 140.5 mAh/g; the initial discharge specific capacity of MoS₂ is decreased from 1074.9 mAh/g to 980.8 mAh/g. At the charge-discharge current density of ⅕ C, the initial charge specific capacity of graphite C is increased from 328 mAh/g to 347 mAh/g. As shown in the figure, the voltage plateau of batteries prepared by these electrode materials has almost no change. Thus, the electrochemical properties of the PEDO:PSS coated electrode materials have not be impaired.

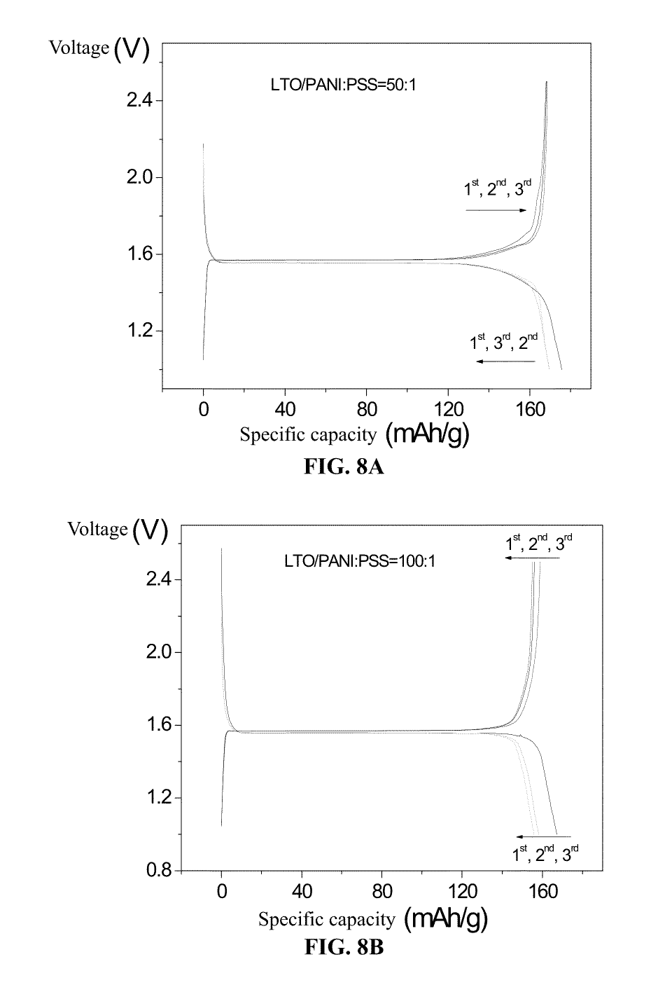

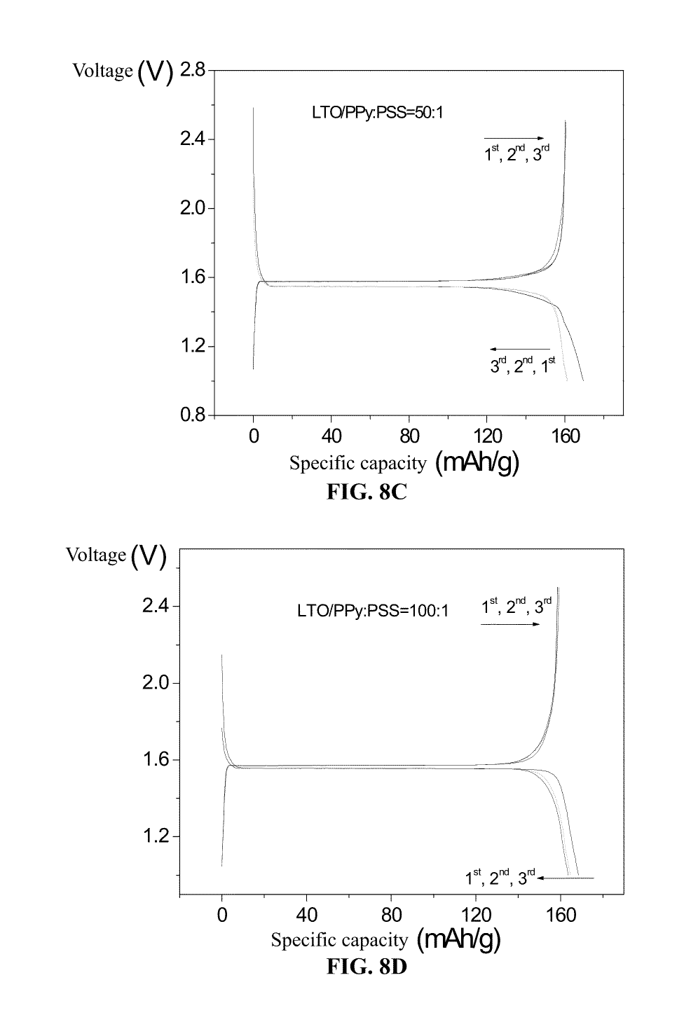

FIG. 8 shows the charge-discharge curves (the first three cycles) of Li₄Ti₅O₁₂ at the current density of 1/10 C after being immersed in different amount of PANI:PSS or PPy:PSS in the presence of supersonic wave. Studies show that the initial discharge capacities of the coated samples have increased. In contrast to LTO, in solutions of LTO/PANI:PSS=50:1, LTO/PANI:PSS=100:1, LTO/PPy: PSS=50:1, LTO/PPy:PSS=100:1, the initial discharge capacities of the samples are increased from 162 mAh/g to 176 mAh/g, to 167 mAh/g, to 169 mAh/g, and to 168 mAh/g, respectively. And as far as the voltage plateau is concerned, there is almost no change

5. Cycle Performance Test

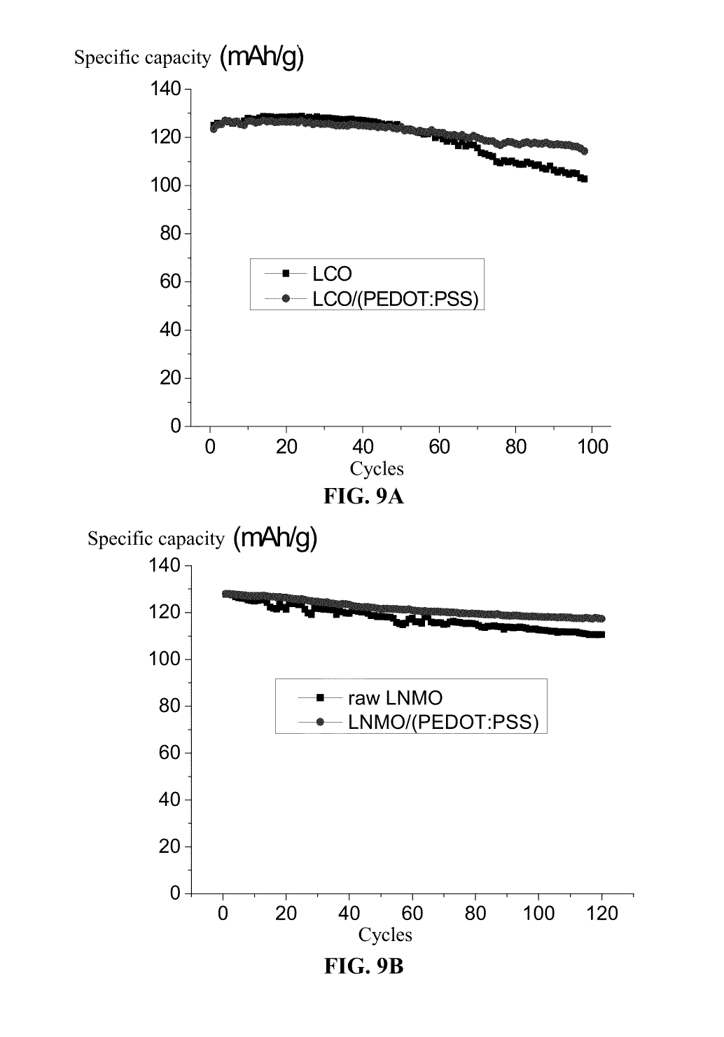

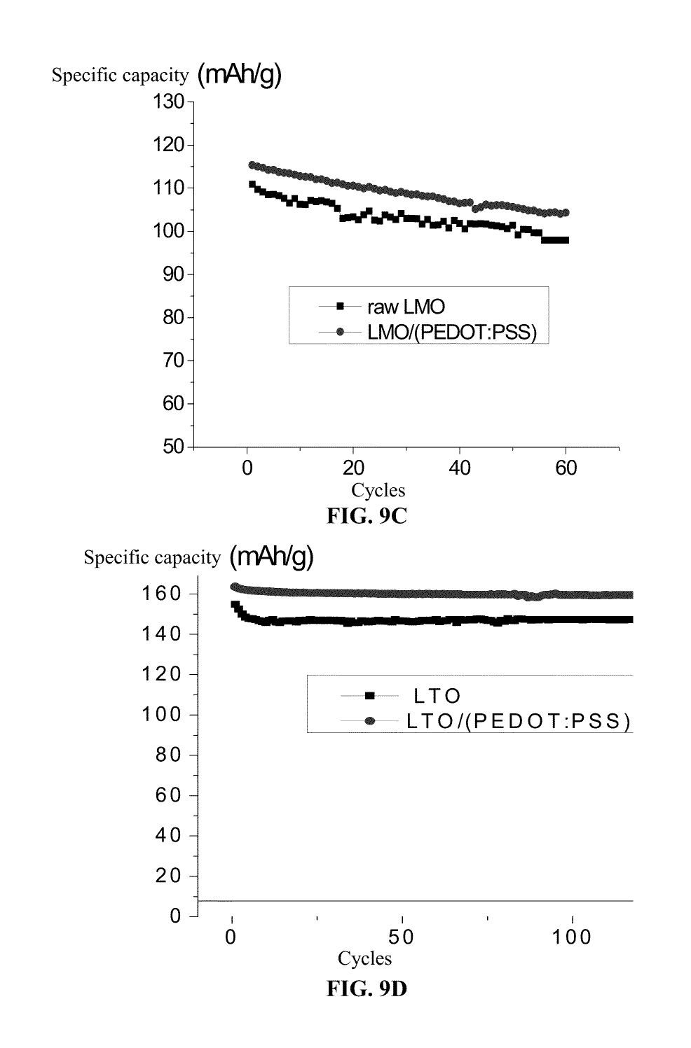

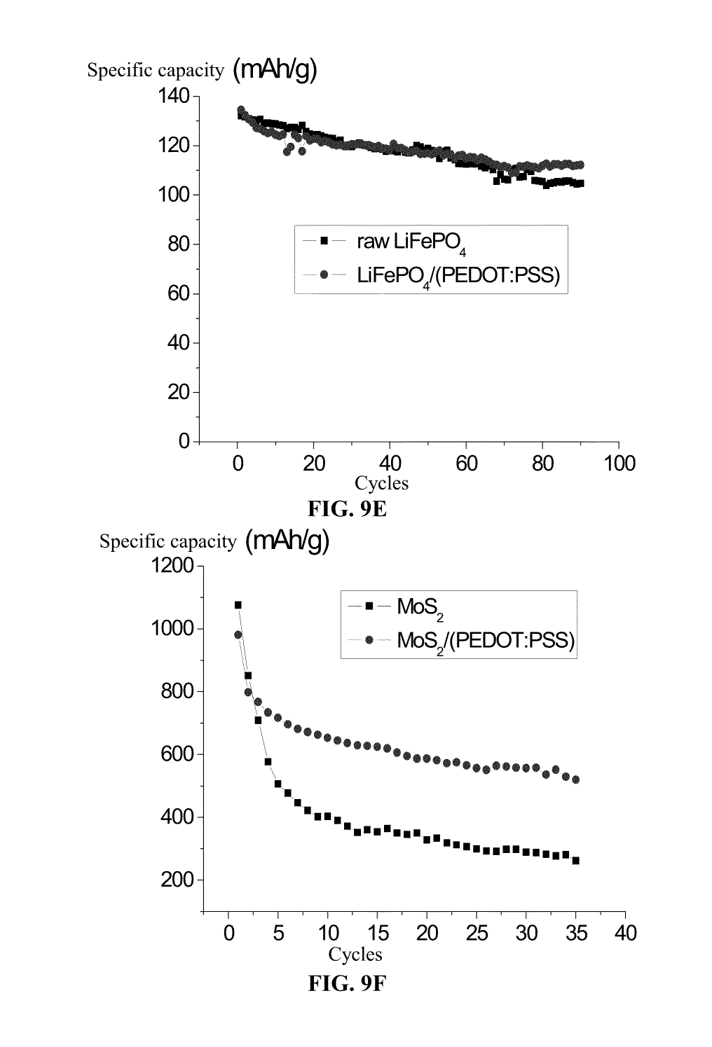

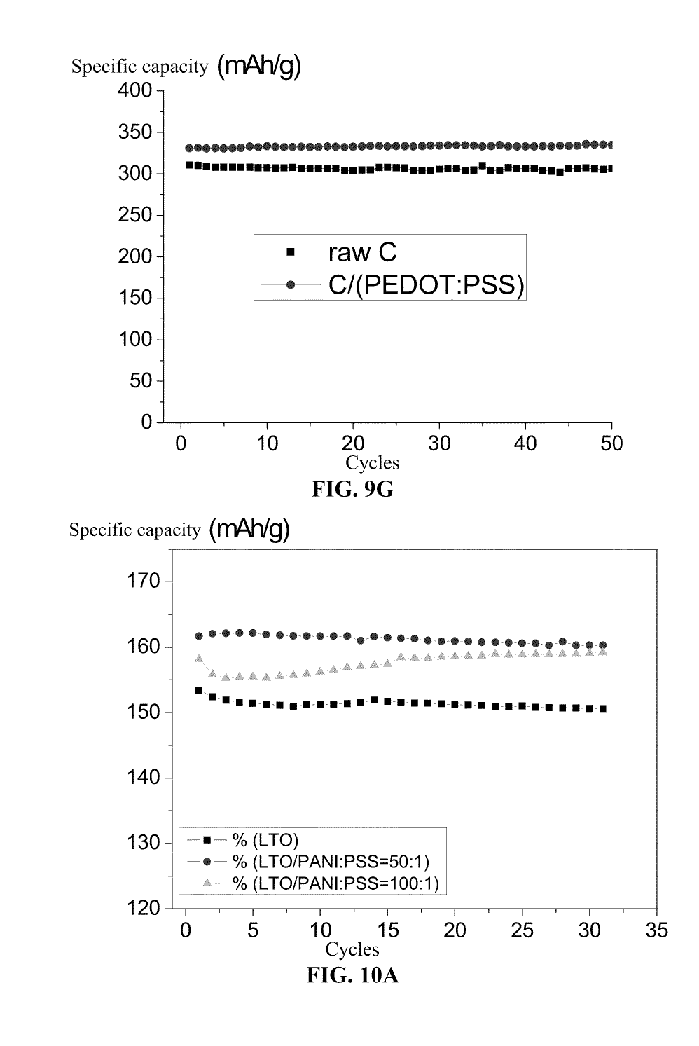

FIG. 9 shows the cycle performance of the materials and composite electrode material involved in the invention at the charge-discharge current density of C/5. As shown in the figure, after being coated by the PEDOT:PSS solution, the discharge specific capacity of the powdery electrode materials (LiCoO₂, LiNi_{0.5}Mn_{1.5}O₄, LiMn₂O₄, Li₄Ti₅O₁₂, LiFePO₄, MoS₂, graphite C) is increased, and the cycle performance is improved significantly.

Specifically, after 100 cycles, the capacity retention of the coated LiCoO₂ is increased from 82.17% to 92.54%, and the discharge specific capacity of the coated LiCoO₂ at the 100^{th} cycle is increased from 102.7 mAh/g to 114.2 mAh/g; after 120 cycles, the capacity retention of the coated of LiNi_{0.5}Mn_{1.5}O₄ is increased from 86.58% to 91.64%, and the discharge specific capacity of the coated LiNi_{0.5}Mn_{1.5}O₄ at the 120^{th} cycle is increased from 110.6 mAh/g to 117.3 mAh/g; after 60 cycles, the capacity retention of the coated of LiMn₂O₄ is increased from 88.28% to 90.45%, and the discharge specific capacity of the coated LiMn₂O₄ at the 60^{th} cycle is increased from 97.9 mAh/g to 104.3 mAh/g; after 150 cycles, the capacity retention of the coated of Li₄Ti₅O₁₂ is increased from 94.9% to 97.2%, and the discharge specific capacity of the coated Li₄Ti₅O₁₂ at the 150^{th} cycle is increased from 147.0 mAh/g to 158.8 mAh/g; after 90 cycles, the capacity retention of the coated of LiFePO₄ is increased from 79.18% to 83.36%, and the discharge specific capacity of the coated LiFePO₄ at the 90^{th} cycle is increased from 104.7 mAh/g to 112.1 mAh/g; after 35 cycles, the capacity retention of the coated of MoS₂ is increased from 30.65% to 65.16%, and the discharge specific capacity of the coated MoS₂ at the 35^{th} cycle is increased from 260.9 mAh/g to 519.3 mAh/g.

At the charge-discharge current density of ½ C, after 50 cycles, the capacity retention of the coated of graphite C is increased from 98.4% to approaching to 100%, and the charge specific capacity of the coated graphite C at the 50^{th} cycle is increased from 305 mAh/g to 335 mAh/g.

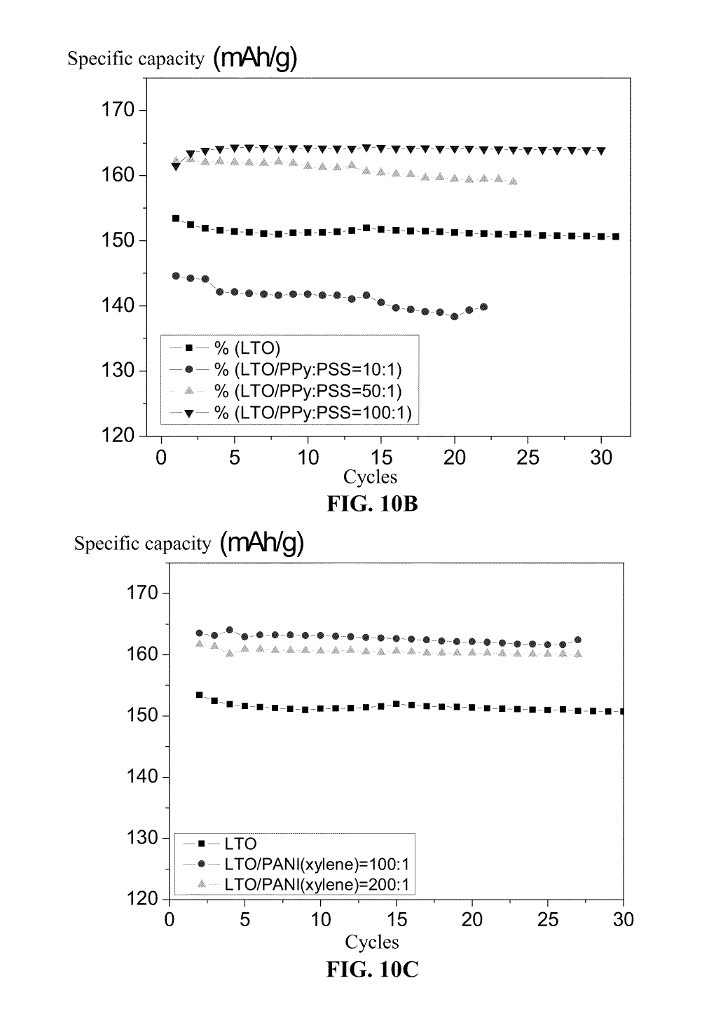

FIGS. 10(A, B, C) shows the cycle performance curves of an electrode prepared by Li₄Ti₅O₁₂ of the invention at the charge-discharge current density of C/10 (1 C=175 mAh/g). As shown in FIGS. 10(A, B), after being coated by a small amount of PANI:PSS, PPy:PSS aqueous solution in the presence of supersonic wave, the discharge specific capacity of the powdery electrode materials is increased, and the cycle performance is improved significantly. When the coating material is in a large amount, for example, LTO/PPy: PSS=10:1, because the PPy:PSS aqueous solution cannot accommodate lithium, the coating layer is much thick, which adversely reduces the discharge specific capacity. When LTO is immersed in the aqueous solution of PANI:PSS, after 32 cycles, when LTO/PANI:PSS=50:1, the capacity retention is increased from 93.79% to 94.12%, and when LTO/PANI:PSS=100:1, the capacity retention is increased from 93.79% to 95.21%. When LTO is immersed in the aqueous solution of PPy:PSS, after 20 cycles, when LTO/PPy:PSS=10:1, the capacity retention is decreased from 93.79% to 83.73%, and when LTO/PPy:PSS=50:1 and LTO/PPy:PSS=100:1, the capacity retentions are increased from 93.79% to 94.12%, and to 100%, respectively. After 20 cycles, the specific capacity of LTO is 151 mAh/g, while when LTO/PANI: PSS=50:1, LTO/PANI:PSS=100:1, LTO/PPy:PSS=50:1, and LTO/PPy:PSS=100:1, the specific capacities are increased to 158 mAh/g, 161 mAh/g, 160 mAh/g, 164 mAh/g, respectively.

As shown in FIG. 10C, after being coated by a small amount of the aqueous solution of PANI(xylene) in the presence of supersonic wave, the discharge specific capacity of LTO is increased, and the cycle performance is improved significantly. After 27 cycles, in contrast to naked LTO, after treatment in LTO/PANI:xylene=100:1, the capacity retention is increased from 93.79% to 95.81%; after treatment in LTO/PANI:xylene=200:1, the capacity retention is increased from 93.79% to 99.07%.

6. Rate Capability Test

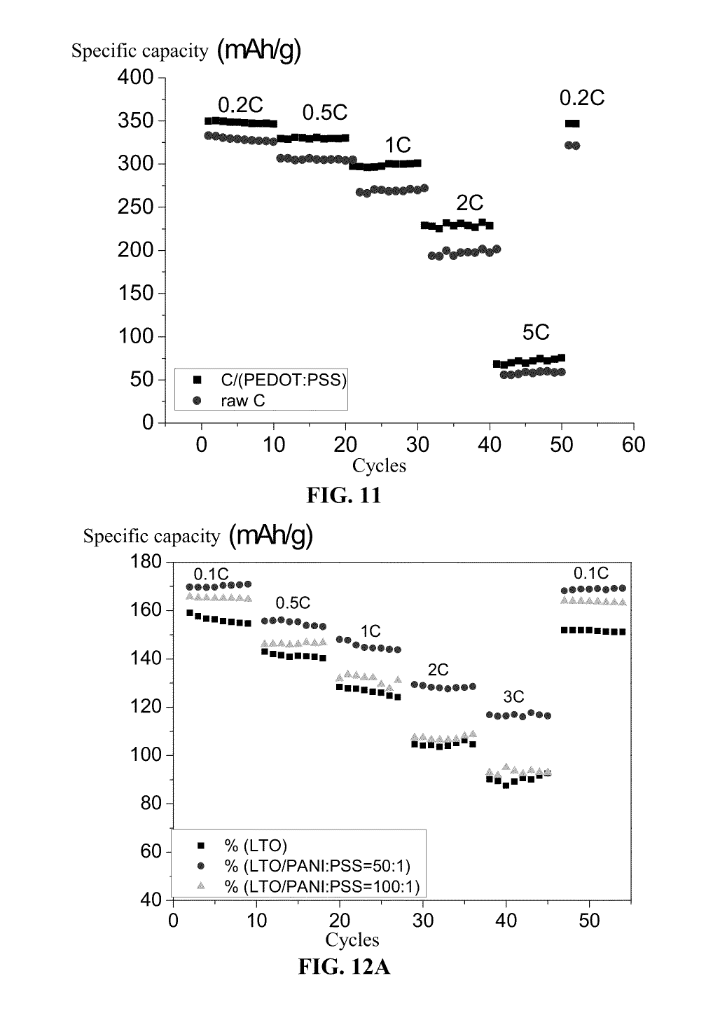

FIG. 11 shows a rate capability curve of a sample of C/PEDOT:PSS of the invention at constant current under different current density. As shown in the figure, the rate capability of the electrode material prepared by coated C/PEDOT:PSS is significantly improved. When the current density is 2 C, the capacity of the battery is increased from 197 mAh/g to 230 mAh/g.

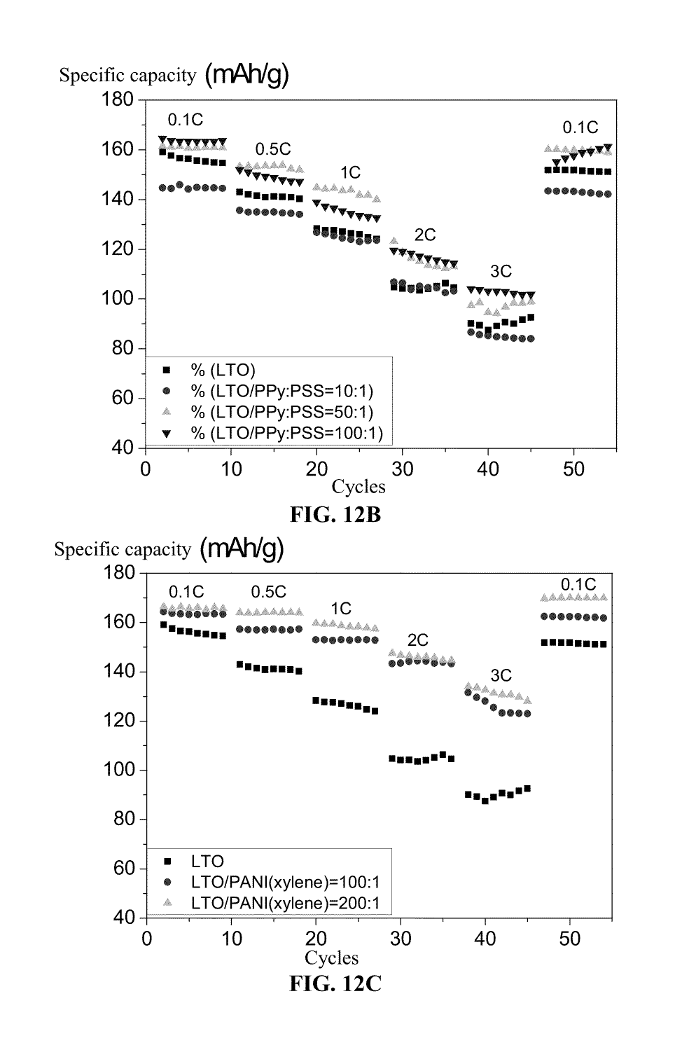

FIGS. 12(A, B, C) shows the rate capability curves of the composite electrode materials involved in the invention at constant current under different current density. As shown in FIGS. 12(A, B), after being coated in solutions of LTO/PANI:PSS=50:1, LTO/PANI:PSS=100:1, LTO/PPy:PSS=50:1, and LTO/PPy:PSS=100:1, the rate capability of the powdery electrode materials is obviously increased. When the weight ratio of LTO to PANI:PSS or PPy:PSS is 50:1, the rate capability of the composite electrode material is the best. When LTO/PANI: PSS=50:1, the rate capability presents good, at the current density of 3 C, the discharge specific capacity is increased from 90 mAh/g to 117 mAh/g.

As shown in FIG. 12C, when the LTO/PANI(xylene) electrode material has a relatively small amount of conductive polymer, the improvement of the rate capability is remarkable, and the cycle is stable, which means the immersing in the organic solvent can produce better coating effect. For example, at the current density of 3 C, the discharge specific capacity of LTO is 90 mAh/g, the discharge specific capacity of LTO/PANI:PSS=50:1 is 117 mAh/g, while the discharge specific capacity of LTO/PANI(xylene)=100:1 is increased to 130 mAh/g.

7. Impedance Test

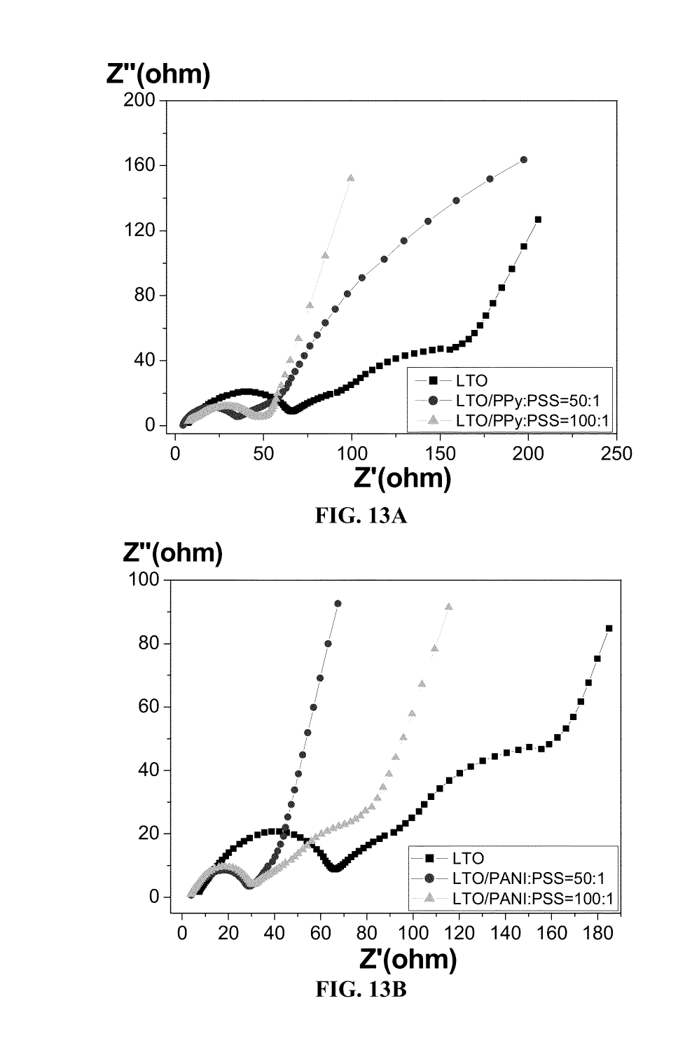

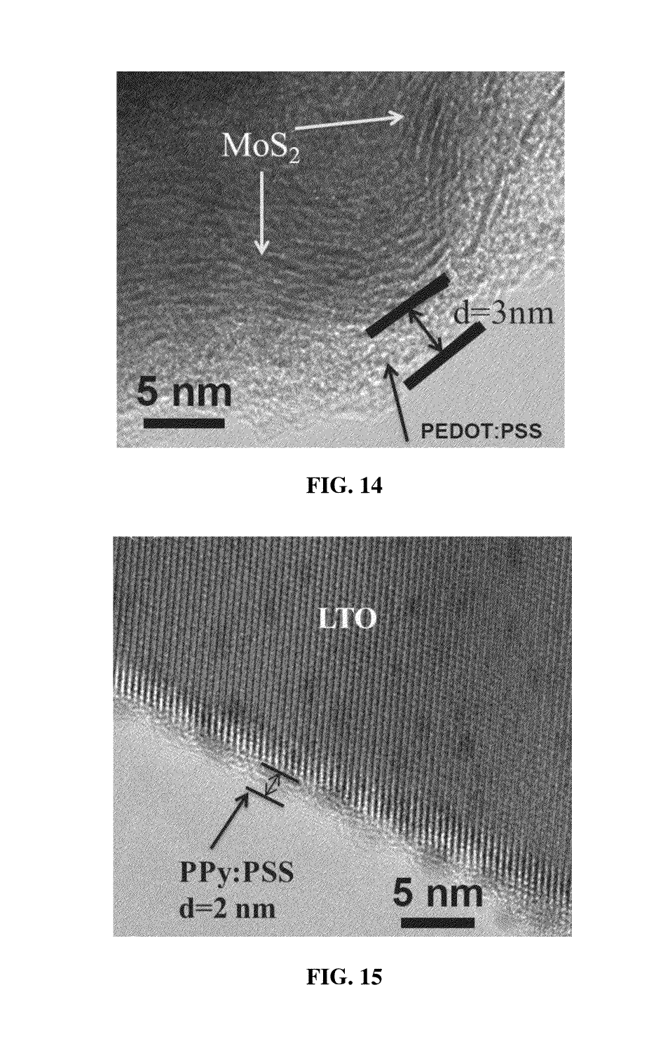

FIG. 13 shows the AC impedance curves of composite electrode materials prepared by LTO/PANI:PSS and LTO/PPy:PSS in the invention after 5 cycles at the charge-discharge current density of C/10 (1 C=175 mAh/g). The test frequency range is between 10 mHz and 100 kHz, the disturbance amplitude is 5 mV, and the open circuit voltage is 1.0 V. In the impedance curves, the semicircle in the high-frequency area is corresponding to the charge transfer on the solid electrolyte interface (SET) membrane formed between the electrolyte and the electrode material. The skew line in the low-frequency area is corresponding to the diffusion of lithium ions in the electrode, which represents the Warburg impedance encountered by the lithium ions when diffusing to the space lattice of the electrode material. As shown in the figure, after the LTO is coated by the conductive polymers LTO/PANI:PSS and LTO/PPy:PSS, the formed SEI membrane is thin and compact, the membrane impedance is greatly reduced. Thus, the coating increases the electroconductibility of the electrode material, facilitates the formation of compact SEI membrane, and improves the rate capability of LTO.

In summary, according to examples of the invention, different kinds of commercial electrode materials are immersed in the aqueous solution or organic solution of the conductive polymer to yield conductive polymer coated electrode materials. The electrode materials have high electroconductibility, high charge and discharge specific capacity, and excellent cycle performance, and are convenient for coating for the preparation of electrode materials. The invention solves the problem of the agglomeration of nano powder of electrode materials. The method of the invention is applicable for compositing of the electrode material and the conductive polymer in other electrochemical energy storage devices (like super capacitors) and organic solar cells (like TiO₂ electrodes in dye-sensitized solar cells).

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A composite electrode material for a lithium ion battery, comprising an electrode material and a conductive polymer, the conductive polymer coating the electrode material, the electrode material being a positive electrode material or a negative electrode material, and the conductive polymer having a tendency to disperse in an aqueous solution or an organic solution in the presence of a doping and dispersing agent and a dispersing medium, wherein the conductive polymer is selected from poly(3,4-ethylenedioxythiophene) (PEDOT), polyaniline (PANT), or polypyrrole (PPy), the doping and dispersing agent is polystyrene sulfonic acid (PSS), and the dispersing medium is water; or the conductive polymer is polyaniline(emeraldine salt), and the dispersing medium is xylene; the composite electrode material is prepared as follows: immersing the positive electrode material or the negative electrode material of the lithium ion battery into an aqueous solution or an organic solution of the conductive polymer, allowing the conductive polymer to uniformly coat a surface of the electrode material with a thickness of several nano-meter level by means of ultrasonic dispersion, and filtering and drying the electrode material to yield a conductive polymer coated electrode material.

2. A method for preparing a composite electrode material, the composite electrode material comprising an electrode material and a conductive polymer, the conductive polymer coating the electrode material, the electrode material being a positive electrode material or a negative electrode material, the conductive polymer having a tendency to disperse in an aqueous solution or an organic solution in the presence of a doping and dispersing agent, an aqueous solution of the conductive polymer being PEDOT:PSS, PANI:PSS, or PPy:PSS, an organic solution of the conductive polymer being a mixture of polyaniline(emeraldine salt) and xylene, and the method comprising: immersing the positive electrode material or the negative electrode material of the lithium ion battery into the aqueous solution or the organic solution of the conductive polymer, allowing the conductive polymer to uniformly coat a surface of the electrode material with a thickness of several nano-meter level by means of ultrasonic dispersion, drying the electrode material to yield a conductive polymer coated electrode material.

3. A method for preparing a composite electrode material of claim 1, comprising:
1) adding dropwise an ammonia solution or an aqueous solution of lithium hydroxide to the aqueous solution or the organic solution of the conductive polymer to adjust a pH value thereof to be between 6 and 9, the aqueous solution of the conductive polymer being PEDOT:PSS, PANI:PSS, or PPy:PSS, and the organic solution of the conductive polymer being a mixture of polyaniline(emeraldine salt) and xylene;
2) adding a powder of the positive electrode material or the negative electrode material of the lithium ion battery to the aqueous solution or the organic solution of the conductive polymer obtained in step 1), dispersing and stirring the aqueous solution or the organic solution of the conductive polymer in the presence of ultrasonic wave;
3) centrifuging/filtering a mixture obtained in step 2) for removal of residual aqueous solution or organic solution to yield a powder; and
4) drying the power obtained in step 3).

4. The method of claim 3, wherein a solid content in the PEDOT:PSS is between 0.9 and 1.3 wt. %, and solid contents in the PANI:PSS and the PPy:PSS are both between 2 and 2.2 wt. %; in the mixture of polyaniline(emeraldine salt) and xylene, a weight percentage of polyaniline(emeraldine salt) is between 2 and 3 wt. %.

5. The method of claim 3, wherein an addition amount of the aqueous solution of the PEDOT:PSS is satisfied to completely immerse the powder of the positive electrode material or the negative electrode material, and an addition amount of the aqueous solution of the PANI:PSS or PPy:PPS is that: a mass ratio of the positive electrode material or the negative electrode material to the conductive polymer is between 10 and 100:1.

6. The method of claim 3, wherein an addition amount of the mixture of polyaniline(emeraldine salt) and xylene is satisfied to completely immerse the powder of the positive electrode material or the negative electrode material, and a mass ratio of the positive electrode material or the negative electrode material to the conductive polymer is between 100 and 200:1.

7. The method of claim 3, wherein in step 2), the positive electrode material or the negative electrode material of the lithium ion battery has a concentration in the aqueous solution or the organic solution of the conductive polymer of between 0.1 and 2 g/mL.

8. The method of claim 3, wherein the positive electrode material of the lithium ion battery comprises LiCoO₂, LiNiO₂, LiMnO₂, LiNi_{0.5}Mn_{1.5}O₄, LiMn₂O₄, LiFePO₄, LiNiₓCo₁₋ₓO₂ wherein x=0.01 to 0.99, a ternary positive electrode material comprising LiMnₓCo_{y}Ni_{z}O₂ and LiNiₓCo_{y}Al_{z}O₂wherein x+y+z=1, or lithium-rich positive material of Li₂MnO₃.(1-x)LiMeO₂wherein 0<x<1, Me=Ni, Co, Mn, or a mixture thereof; and the negative electrode material of the lithium ion battery comprises MoS₂, graphite, Li₄Ti₅O₁₂, and silicon-based negative materials, or a mixture thereof.

9. The method of claim 3, wherein a dispersion time of the aqueous solution or the organic solution of the conductive polymer is between 0.2 and 3 hours.
